(19) United States
(12) Patent Application Publication
(10) Pub. No.: US 2021/0240257 A1
(43) Pub. Date: Aug. 5, 2021

(54) HIDING LATENCY IN WIRELESS VIRTUAL AND AUGMENTED REALITY SYSTEMS

(71) Applicant: ATI Technologies ULC, Markham (CA)

(72) Inventors: Mikhail Mironov, Markham (CA); Gennadiy Kolesnik, Markham (CA); Pavel Siniavine, Markham (CA)

(21) Appl. No.: 16/778,767

(22) Filed: Jan. 31, 2020

(51) Int. Cl. G06F 3/01; G06T 19/00; G02B 27/01; G06F 3/14; H04N 19/463; H04N 19/61

(52) U.S. Cl. CPC G06F 3/012; G06T 19/006; G02B 27/017; G02B 2027/0187; H04N 19/463; H04N 19/61; G06F 3/14

(57) ABSTRACT

Systems, apparatuses, and methods for hiding latency for wireless virtual reality (VR) and augmented reality (AR) applications are disclosed. A wireless VR or AR system includes a transmitter rendering, encoding, and sending video frames to a receiver coupled to a head-mounted display (HMD). In one scenario, the receiver measures a total latency required for the system to render a frame and prepare the frame for display. The receiver predicts a future head pose of a user based on the total latency. Next, a rendering unit at the transmitter renders, based on the predicted future head pose, a new frame with a rendered field of view (FOV) larger than a FOV of the headset. The receiver rotates the new frame by an amount determined by the difference between the actual head pose and the predicted future head pose to generate a rotated version of the new frame for display.

### BACKGROUND

### Description of the Related Art

In order to create an immersive environment for the user, virtual reality (VR) and augmented reality (AR) video streaming applications typically require high resolution and high frame-rates, which equates to high data-rates. For VR and AR headsets or head mounted displays (HMDs), rendering at high and consistent frame rates provides a smooth and immersive experience. However, rendering time may fluctuate depending on the complexity of the scene, occasionally resulting in a rendered frame being delivered late for presentation. Additionally, as the user changes their orientation within a VR or AR scene, the rendering unit will change the perspective from which the scene is rendered.

In many cases, the user can perceive a lag between their movement and the corresponding update to the image presented on the display. This lag is caused by the latency inherent in the system, with the latency referring to the time between when a movement of the user is captured and when the image reflecting this movement appears on the screen of the HMD. For example, while the system is rendering a frame, the user can move their head, causing the locations of the scenery being rendered in the frame to be inaccurate based on the user's new head pose. In one implementation, the term “head pose” is defined as both the position of the head (e.g., the X, Y, Z coordinates in the three-dimensional space) and the orientation of the head. The orientation of the head can be specified as a quaternion, as a set of three angles called the Euler angles, or otherwise.

Wireless VR/AR systems typically introduce an additional latency compared to wired systems. Without special techniques to hide this additional latency, the images presented in the HMD will judder and lag in case of head movements, breaking immersion and causing nausea and eye strain.

### BRIEF DESCRIPTION OF THE DRAWINGS

The advantages of the methods and mechanisms described herein may be better understood by referring to the following description in conjunction with the accompanying drawings, in which:

FIG. 1 is a block diagram of one implementation of a system.

FIG. 2 is a block diagram of one implementation of a system.

FIG. 3 is a diagram of one example of a rendering environment for a VR/AR application.

FIG. 4 is a diagram of one example of a technique to counteract late head movement in a VR/AR application.

FIG. 5 is a diagram of one example of adjusting a frame being displayed for a wireless VR/AR application based on late head movement.

FIG. 6 is a generalized flow diagram illustrating one implementation of a method for hiding the latency of a wireless VR/AR system.

FIG. 7 is a generalized flow diagram illustrating one implementation of a method for measuring total latency for a wireless VR/AR to render and display a frame from start to finish.

FIG. 8 is a generalized flow diagram illustrating one implementation of a method for updating a model for predicting a future head pose of a user.

FIG. 9 is a generalized flow diagram illustrating one implementation of a method for dynamically adjusting a size of a rendering FOV based on an error in a future head pose prediction.

FIG. 10 is a generalized flow diagram illustrating one implementation of a method for dynamically adjusting a rendering FOV.

### DETAILED DESCRIPTION OF IMPLEMENTATIONS

In the following description, numerous specific details are set forth to provide a thorough understanding of the methods and mechanisms presented herein. However, one having ordinary skill in the art should recognize that the various implementations may be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

Various systems, apparatuses, methods, and computer-readable mediums for hiding latency for wireless virtual and augmented reality applications are disclosed herein. In one implementation, a virtual reality (VR) or augmented reality (AR) system includes a transmitter rendering, encoding, and sending video frames to a receiver coupled to a head-mounted display (HMD). In one scenario, the receiver measures a total latency required for the system to render a frame and prepare the frame for display. The receiver predicts a future head pose of a user based on a measurement of the latency and based on a prediction of a user head movement. Then, the receiver conveys an indication of the predicted future head pose to a rendering unit of the transmitter. Next, the rendering unit renders, based on the predicted future head pose, a new frame with a rendered field of view (FOV) larger than a FOV of the headset. Then, the rendering unit conveys the rendered new frame to the receiver for display. The receiver measures an actual head pose of the user in preparation for displaying the new frame. Then, the receiver calculates a difference between the actual head pose and the predicted head pose. The receiver rotates the new frame by an amount determined by the difference to generate a rotated version of the new frame (e.g., the field of view is shifted vertically and/or horizontally to match how the user moved their head after rendering started). Then, the receiver displays the rotated version of the new frame.

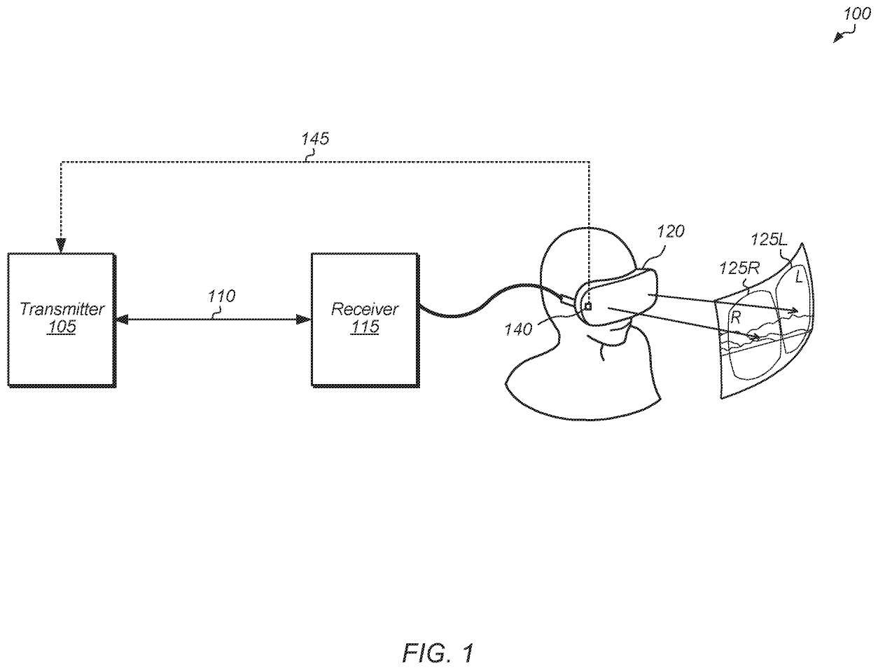

Referring now to FIG. 1, a block diagram of one implementation of a system 100 is shown. In one implementation, system 100 includes transmitter 105, channel 110, receiver 115, and head-mounted display (HMD) 120. It is noted that in other implementations, system 100 can include other components than are shown in FIG. 1. In one implementation, channel 110 is a wireless connection between transmitter 105 and receiver 115. In another implementation, channel 110 is representative of a network connection between transmitter 105 and receiver 115. Any type and number of networks can be employed depending on the implementation to provide the connection between transmitter 105 and receiver 115. For example, transmitter 105 is part of a cloud-service provider in one particular implementation.

In one implementation, transmitter 105 receives a video sequence to be encoded and sent to receiver 115. In another implementation, transmitter 105 includes a rendering unit which is rendering the video sequence to be encoded and transmitted to receiver 115. In one implementation, the rendering unit generates rendered images from graphics information (e.g., raw image data). It is noted that the terms “image”, “frame”, and “video frame” can be used interchangeably herein. In one implementation, within each image that is displayed on HMD 120, a right-eye portion of the image is driven to the right side 125R of HMD 120 while a left-eye portion of the image is driven to left side 125L of HMD 120. In one implementation, receiver 115 is separate from HMD 120, and receiver 115 communicates with HMD 120 using a wired or wireless connection. In another implementation, receiver 115 is integrated within HMD 120.

In order to hide the latency of the various operations being performed by system 100, various techniques for predicting a future head pose, rendering a wider field of view (FOV) than a display based on the predicted future head pose, and adjusting the final frame based on a difference between the predicted future head pose and the actual head pose at the time the final frame is being prepared for display are used by system 100. In one implementation, the head pose of the user is determined based on one or more head tracking sensors 140 within HMD 120. In one implementation, receiver 115 measures a total latency of system 100 and predicts a future head pose of the user based on the current head pose measurement and based on the measured total latency. In other words, receiver 115 determines the point in time when the next frame will be displayed based on the measured total latency, and receiver 115 predicts where the user's head and/or eyes will be directed at that point in time. In one implementation, the term “total latency” is defined as the time between taking a measurement of the user's head pose and displaying an image reflecting this head pose. In various implementations, the amount of time needed for rendering may fluctuate depending on the complexity of the scene, occasionally resulting in a rendered frame being delivered late for presentation. As the rendering time fluctuates, the total latency varies, increasing the importance of the measurements taken by receiver 115 to track the total latency of the system 100.

After making the prediction, receiver 115 sends an indication of the predicted future head pose to transmitter 105. In one implementation, the predicted future head pose information is transmitted from receiver 115 to transmitter 105 using communication interface 145 which is separate from channel 110. In another implementation, the predicted future head pose information is transmitted from receiver 115 to transmitter 105 using channel 110. In one implementation, transmitter 105 renders a frame based on the predicted future head pose. Also, transmitter 105 renders the frame with a wider FOV than a headset FOV. Transmitter 105 encodes and transmits the frame to receiver 115, and receiver 115 decodes the frame. As receiver 115 is preparing the decoded frame for display, receiver 115 determines the current head pose of the user and calculates the difference between the predicted future head pose and the current head pose. Then, receiver 115 rotates the frame based on the difference and drives the rotated frame to the display. These and other techniques will be described in more detail throughout the remainder of this disclosure.

Transmitter 105 and receiver 115 are representative of any type of communication devices and/or computing devices. For example, in various implementations, transmitter 105 and/or receiver 115 can be a mobile phone, tablet, computer, server, HMD, another type of display, router, or other types of computing or communication devices. In one implementation, system 100 executes a virtual reality (VR) application for wirelessly transmitting frames of a rendered virtual environment from transmitter 105 to receiver 115. In other implementations, other types of applications (e.g., augmented reality (AR) applications) can be implemented by system 100 that take advantage of the methods and mechanisms described herein.

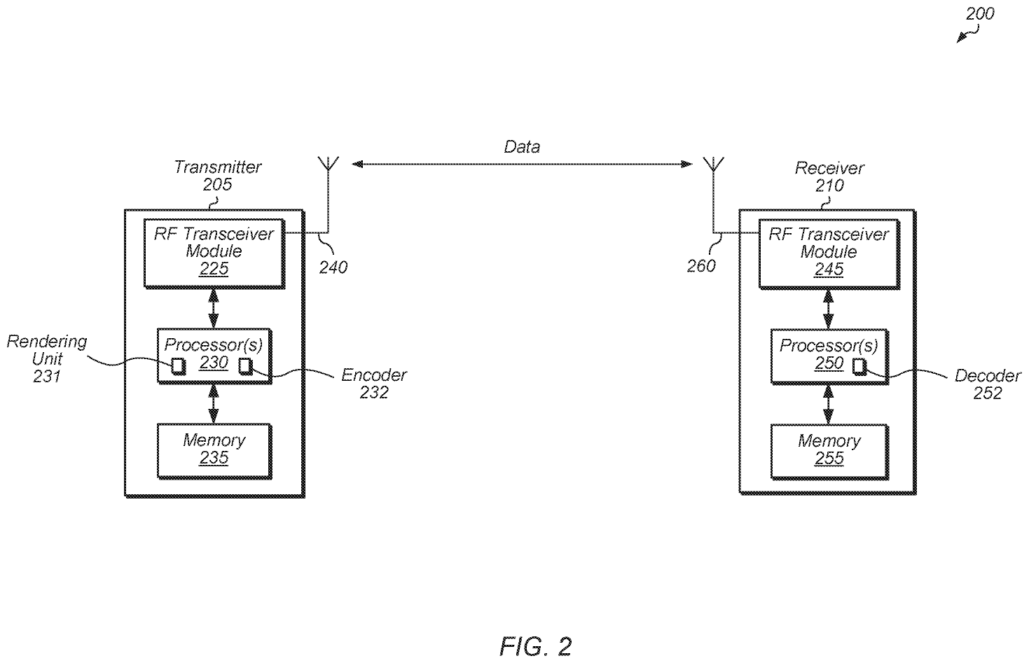

Turning now to FIG. 2, a block diagram of one implementation of a system 200 is shown. System 200 includes at least a first communications device (e.g., transmitter 205) and a second communications device (e.g., receiver 210) operable to communicate with each other wirelessly. It is noted that transmitter 205 and receiver 210 can also be referred to as transceivers. In one implementation, transmitter 205 and receiver 210 communicate wirelessly over the unlicensed 60 Gigahertz (GHz) frequency band. For example, in this implementation, transmitter 205 and receiver 210 communicate in accordance with the Institute of Electrical and Electronics Engineers (IEEE) 802.11ad standard (i.e., WiGig). In other implementations, transmitter 205 and receiver 210 communicate wirelessly over other frequency bands and/or by complying with other wireless communication protocols, whether according to a standard or otherwise. For example, other wireless communication protocols that can be used include, but are not limited to, Bluetooth®, protocols utilized with various wireless local area networks (WLANs), WLANs based on the Institute of Electrical and Electronics Engineers (IEEE) 802.11 standards (i.e., WiFi), mobile telecommunications standards (e.g., CDMA, LTE, GSM, WiMAX), etc.

Transmitter 205 and receiver 210 are representative of any type of communication devices and/or computing devices. For example, in various implementations, transmitter 205 and/or receiver 210 can be a mobile phone, tablet, computer, server, head-mounted display (HMD), television, another type of display, router, or other types of computing or communication devices. In one implementation, system 200 executes a virtual reality (VR) application for wirelessly transmitting frames of a rendered virtual environment from transmitter 205 to receiver 210. In other implementations, other types of applications can be implemented by system 200 that take advantage of the methods and mechanisms described herein.

In one implementation, transmitter 205 includes at least radio frequency (RF) transceiver module 225, processor 230, memory 235, and antenna 240. RF transceiver module 225 transmits and receives RF signals. In one implementation, RF transceiver module 225 is a mm-wave transceiver module operable to wirelessly transmit and receive signals over one or more channels in the 60 GHz band. RF transceiver module 225 converts baseband signals into RF signals for wireless transmission, and RF transceiver module 225 converts RF signals into baseband signals for the extraction of data by transmitter 205. It is noted that RF transceiver module 225 is shown as a single unit for illustrative purposes. It should be understood that RF transceiver module 225 can be implemented with any number of different units (e.g., chips) depending on the implementation. Similarly, processor 230 and memory 235 are representative of any number and type of processors and memory devices, respectively, that are implemented as part of transmitter 205. In one implementation, processor 230 includes rendering unit 231 to render frames of a video stream and encoder 232 to encode (i.e., compress) the video stream prior to transmitting the video stream to receiver 210. In other implementations, rendering unit 231 and/or encoder 232 are implemented separately from processor 230. In various implementations, rendering unit 231 and encoder 232 are implemented using any suitable combination of hardware and/or software.

Transmitter 205 also includes antenna 240 for transmitting and receiving RF signals. Antenna 240 represents one or more antennas, such as a phased array, a single element antenna, a set of switched beam antennas, etc., that can be configured to change the directionality of the transmission and reception of radio signals. As an example, antenna 240 includes one or more antenna arrays, where the amplitude or phase for each antenna within an antenna array can be configured independently of other antennas within the array. Although antenna 240 is shown as being external to transmitter 205, it should be understood that antenna 240 can be included internally within transmitter 205 in various implementations. Additionally, it should be understood that transmitter 205 can also include any number of other components which are not shown to avoid obscuring the figure. Similar to transmitter 205, the components implemented within receiver 210 include at least RF transceiver module 245, processor 250, decoder 252, memory 255, and antenna 260, which are analogous to the components described above for transmitter 205. It should be understood that receiver 210 can also include or be coupled to other components (e.g., a display).

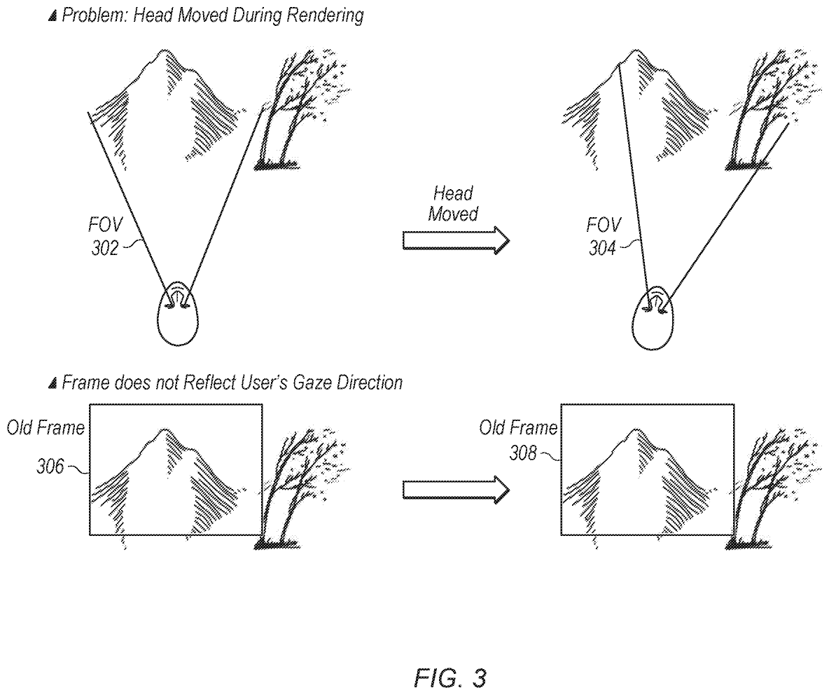

Referring now to FIG. 3, a diagram of one example of a rendering environment for a VR/AR application is shown. At the top left of FIG. 3, field of view (FOV) 302 shows the scenery being rendered according to one example of a frame in a VR/AR application, with FOV 302 oriented according to the current head pose of the user with the user looking straight ahead. Old frame 306 at the bottom left of FIG. 3 shows the scenery that will be displayed to the user based on the scenery of the VR/AR application and based on the position and orientation of their head at the point in time captured by FOV 302.

Then, on the top right of FIG. 3, FOV 304 shows a new FOV based on the user moving their head. However, if the head move occurs after rendering of the frame has started, then old frame 308 at the bottom right of FIG. 3 will be displayed to the user since the head movement was not captured in time to update the rendering of the frame. This will have an unpleasant effect on the user's viewing experience because the scenery will not change as the user expects. Accordingly, techniques to prevent and/or offset this negative viewing experience are desired. It is noted that while the example of the user moving their head is depicted in FIG. 3, a similar effect can occur if the user moves the gaze direction of their eyes after rendering of the frame has commenced.

While the example of head pose is used herein to describe the user's gaze direction, it should be understood that different types of sensors can be used to detect the position of other parts of the user's body. For example, sensors can detect eye movement by the user in some applications. In another example, if the user is holding an object that is supposed to interact with the scenery, the sensors can detect the movement of this object. For example, in one implementation, an object can function as a flashlight, and as the user changes the direction that the object is pointing, the user will expect to see a different area within the scenery illuminated. If the new area is not illuminated as expected, the user will notice the discrepancy and their overall experience will be diminished. Other types of VR/AR applications can utilize other objects or effects that the user will expect to see presented on the display. These other types of VR/AR applications can also benefit from the techniques presented herein.

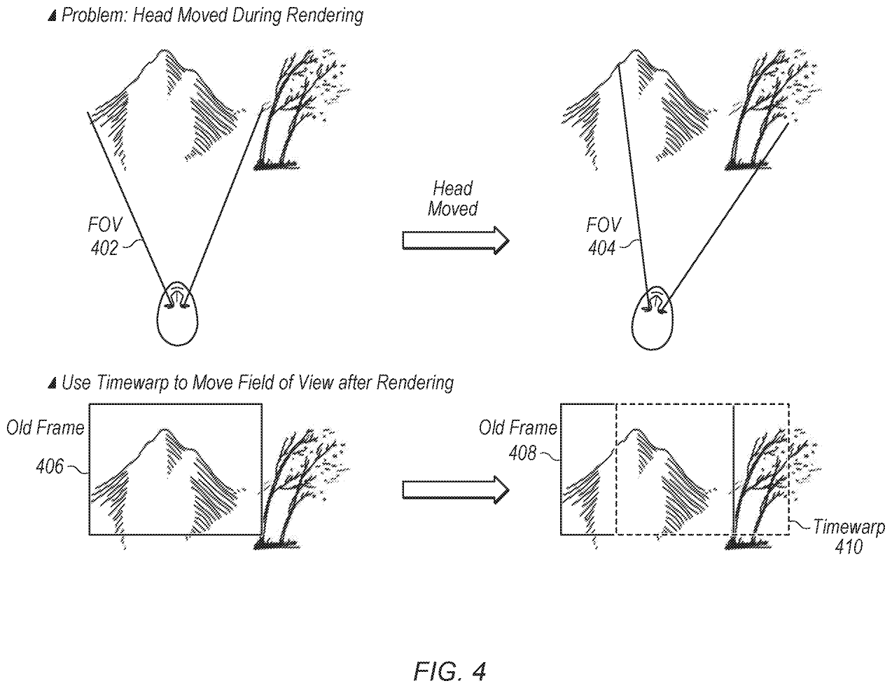

Turning now to FIG. 4, a diagram of one example of a technique to counteract late head movement in a VR/AR application is shown. FOV 402 at the top left of FIG. 4 illustrates the original position and orientation of the user's head with respect to the scene being rendered in a VR/AR application. Old frame 406 at the bottom left of FIG. 4 illustrates the frame that is being rendered and will be displayed to the user on the HMD based on their current head pose. Accordingly, old frame 406 reflects the proper positioning of the scenery being rendered for FOV 402 based on the user's head pose that was captured immediately before rendering started.

FOV 404 at the top right of FIG. 4 illustrates a head movement by the user after rendering was initiated. However, old frame 408 will still be displayed to the user if nothing is done to update the scenery based on the user's head movement. In one implementation, a timewarp technique is used to adjust the frame presented to the user based on late movement. Accordingly, timewarp frame 410 next to old frame 408 on the bottom right of FIG. 4 illustrates the use of the timewarp technique to cause the scenery that is displayed to reflect the updated FOV 404. The timewarp technique used for generating timewarp frame 410 involves using a re-projection technique to fill the content gaps and maintain immersion. Re-projection includes applying various techniques to pixel data from previous frames to synthesize the missing portions of timewarp frame 410. The timewarp technique shifts the user's FOV using the latest head pose data from the headset's sensors while still displaying the previous frame, providing an illusion of smooth movement when the user moves their head. However, a typical timewarp technique causes the frame margins in the direction of head movement to become incomplete and typically filled with black, reducing the effective FOV of the headset.

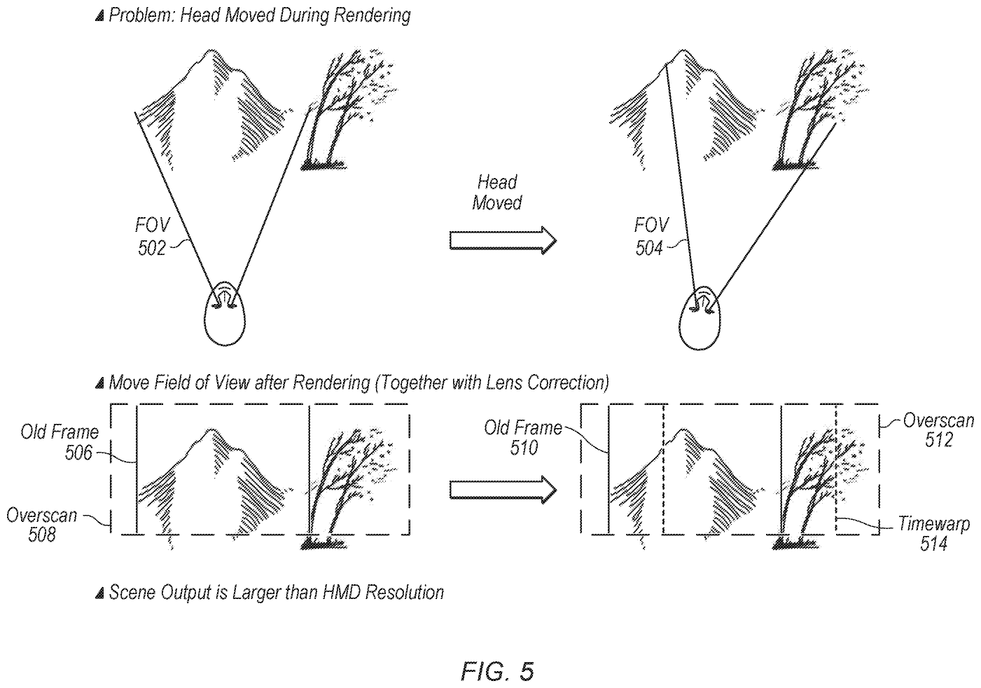

Referring now to FIG. 5, a diagram of one example of adjusting a frame being displayed for a wireless VR/AR application based on late head movement is shown. FOV 502 is shown at the top left of FIG. 5 for one example of the scenery of a VR/AR application for the current head pose of a user. Old frame 506 at the bottom left of FIG. 5 illustrates the frame as it will be rendered based on the current head pose of the user. However, the scenery being rendered can actually be expanded in both the left and right directions to provide additional areas which can be used for the final frame in case the user moves their head after rendering commences.

On the top-right of FIG. 5, FOV 504 shows the updated FOV after the user has moved their head. If corrective action is not taken, the user will see old frame 506. Old frame 510 shown at the bottom right of FIG. 5 shows a technique which is used in one implementation to correct for the late head movement. In this case, extra areas around the frame shown in overscan region 508 on the bottom-left of FIG. 5 are rendered and sent to the HMD. In timewarp frame 514 on the bottom-right of FIG. 5, the borders of the frame are shifted to the right using pixels within overscan region 512 to adjust for the user's new head pose. By shifting the borders of old frame 510 to the right as indicated by the dashed lines of timewarp frame 514, the extra area within the overscan region 508 to the right of the original frame 506 that was rendered and sent to the HMD is used and displayed to the user. As shown in FIG. 5, a timewarp technique is combined with an overscan technique to synthesize an image to substitute for a frame rendered with an obsolete head location. The combination of these techniques creates an illusion of smoother movements.

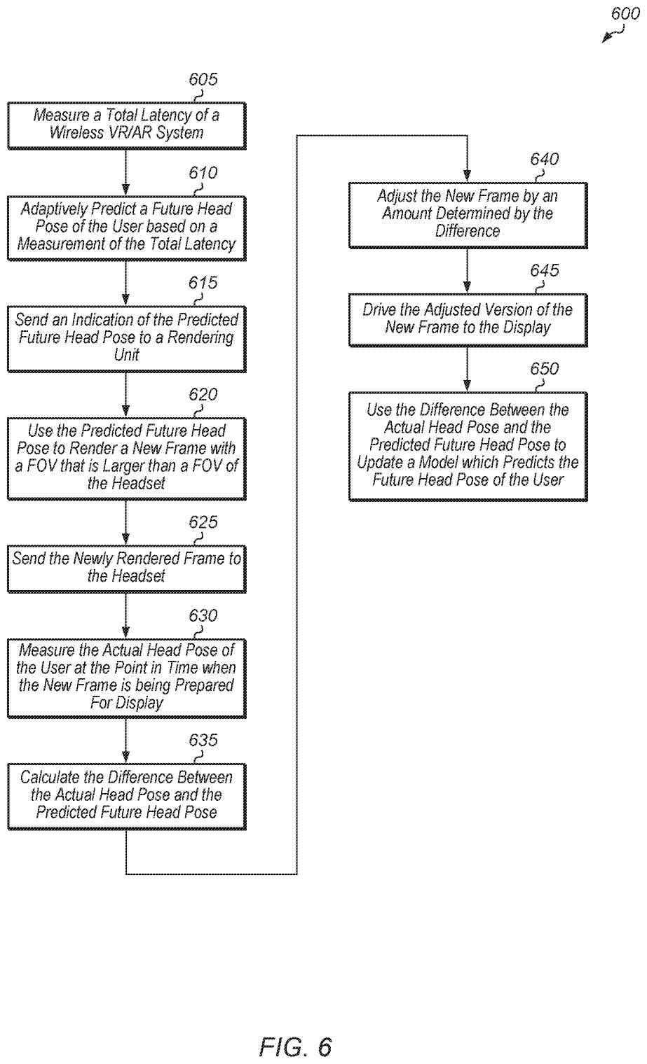

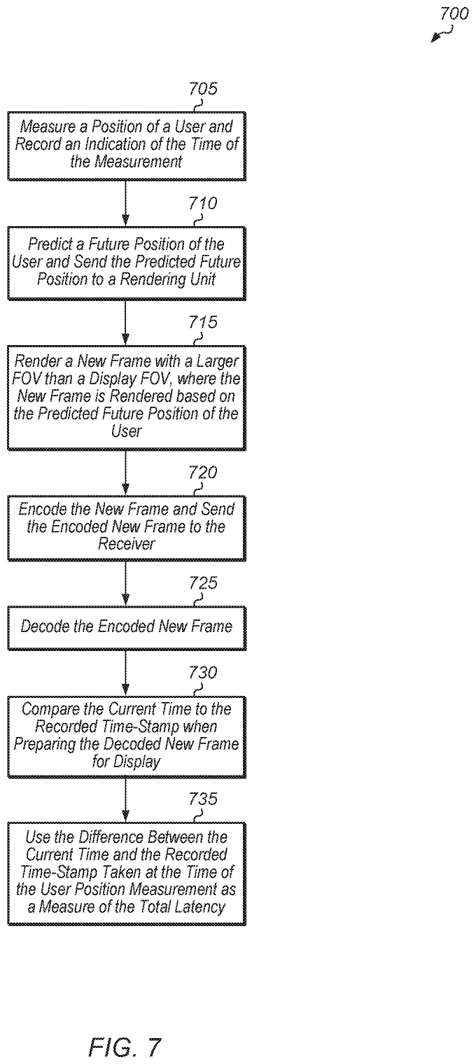

Turning now to FIG. 6, one implementation of a method 600 for hiding the latency of a wireless VR/AR system is shown. For purposes of discussion, the steps in this implementation and those of FIG. 7-10 are shown in sequential order. However, it is noted that in various implementations of the described methods, one or more of the elements described are performed concurrently, in a different order than shown, or are omitted entirely. Other additional elements are also performed as desired. Any of the various systems or apparatuses described herein are configured to implement method 600.

A receiver measures a total latency of a wireless VR/AR system (block 605). In one implementation, the total latency is measured from a first point in time when a given head pose is measured to a second point in time when a frame reflecting the given head pose is displayed. One example of measuring the latency of a wireless VR/AR system is described in further detail below in the discussion associated with method 700 (of FIG. 7). In some cases, the average total latency is calculated over several frame cycles and used in block 605. In another implementation, the most recently calculated total latency is used in block 605.

The headset adaptively predicts a future head pose of the user based on a measurement of the total latency (block 610). In other words, the headset predicts where the gaze of the user will be directed at the point in time when the next frame will be displayed. The point in time when the next frame will be displayed is calculated by adding the measurement of the latency to the current time. In one implementation, the headset uses historical head pose data to extrapolate forward to the point in time when the next frame will be displayed to generate a prediction for the future head pose of the user. Next, the headset sends an indication of the predicted head pose to a rendering unit (block 615).

Then, the rendering unit uses the predicted future head pose to render a new frame with a field of view (FOV) that is larger than a FOV of the headset (block 620). In one implementation, the FOV of the newly rendered frame is larger than the headset FOV in the horizontal direction. In another implementation, the FOV of the newly rendered frame is larger than the headset FOV in both the vertical direction and in the horizontal direction. Next, the newly rendered frame is sent to the headset (block 625). Then, the headset measures the actual head pose of the user at the point in time when the new frame is being prepared for display on the headset (block 630). Next, the headset calculates the difference between the actual head pose and the predicted future head pose (block 635). Then, the headset adjusts the new frame by an amount determined by the difference (block 640). It is noted that the adjustment to the new frame performed in block 640 can also be referred to as a rotation. This adjustment is applicable to two-dimensional linear movements, three-dimensional rotational movements, or a combination of linear and rotational movements.

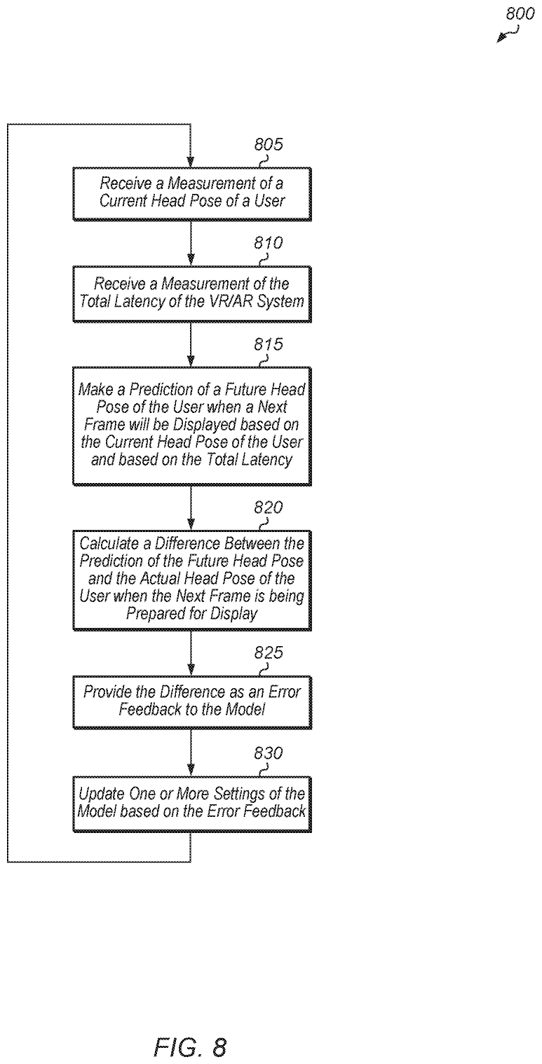

Next, the adjusted version of the new frame is driven to the display (block 645). Also, the difference between the actual head pose and the predicted head pose is used to update a model which predicts the future head pose of the user (block 650). One example of using the difference between the actual head pose and the predicted head pose to update the model which predicts the future head pose of the user is described in the discussion associated with method 800 of FIG. 8. After block 650, method 600 ends. It is noted that method 600 can be performed for each frame that is rendered and displayed on the headset.

Referring now to FIG. 7, one implementation of a method 700 for measuring total latency for a wireless VR/AR to render and display a frame from start to finish is shown. A receiver measures a position of a user and records an indication of the time of the measurement (block 705). The position of the user can refer to the user's head pose, the gaze direction of the user's eyes, or the location of some other part of the user's body. For example, in some implementations, the receiver detects hand gestures or the position of other parts (e.g., feet, legs) of the body. In one implementation, the indication of the time of the measurement is a time-stamp. In another implementation, the indication of the time of the measurement is a value of a running counter. Other ways of recording the time when the receiver measure the position of the user are possible and are contemplated.

Next, the receiver predicts a future position of the user and sends the predicted future position to a rendering unit (block 710). The rendering unit renders a new frame with a larger FOV than a display FOV, where the new frame is rendered based on the predicted future position of the user (block 715). Next, the rendering unit encodes the new frame and then sends the encoded new frame to the receiver (block 720). Then, the headset decodes the encoded new frame (block 725). Next, when preparing the decoded new frame for display, the receiver compares the current time to the recorded time-stamp (block 730). The difference between the current time and the recorded time-stamp taken at the time of the user position measurement is used as a measure of the total latency (block 735). After block 735, method 700 ends.

Turning now to FIG. 8, one implementation of a method 800 for updating a model for predicting a future head pose of a user is shown. A model receives a measurement of a current head pose of a user (block 805). The model also receives a measurement of the total latency of the VR/AR system (block 810). The model makes a prediction of a future head pose at the point in time when a next frame will be displayed based on the current head pose of the user and based on the total latency (block 815). Later, when the actual head pose of the user is measured when the next frame is being prepared for display, the difference between the model's prediction and the actual head pose is calculated (block 820). Then, the difference is provided as an error input to the model (block 825). Next, the model updates one or more settings based on the error input (block 830). In one implementation, the model is a neural network which uses backward propagation to adjust the weights of the network in response to error feedback. After block 830, method 800 returns to block 805. For the next iteration through method 800, the model will make a subsequent prediction using the one or more updated settings.

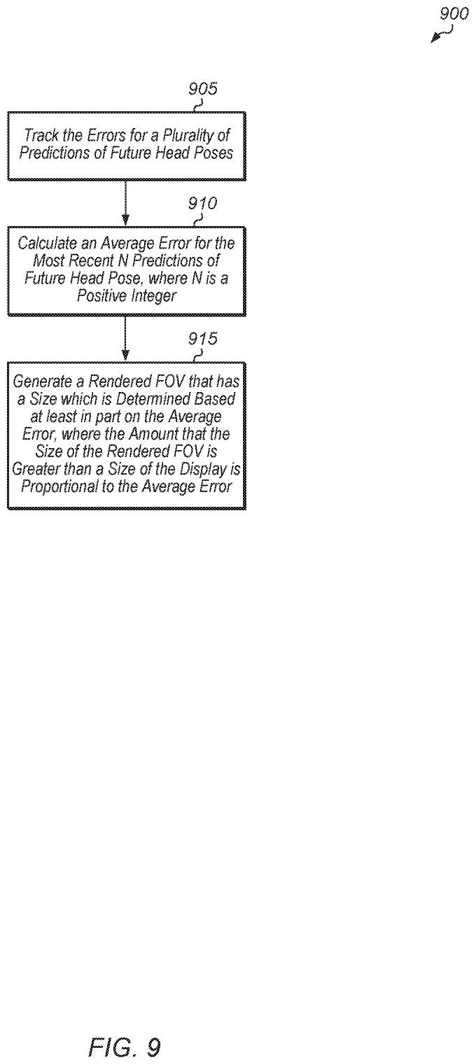

Referring now to FIG. 9, one implementation of a method 900 for dynamically adjusting a size of a rendering FOV based on an error in a future head pose prediction is shown. A receiver tracks the errors for a plurality of predictions of future head poses (block 905). The receiver calculates an average error for the most recent N predictions of future head pose, where N is a positive integer (block 910). Then, a rendering unit generates a rendered FOV that has a size which is determined based at least in part on the average error, where the amount that the size of the rendered FOV is larger than a size of the display is proportional to the average error (block 915). After block 915, method 900 ends. By performing method 900, the size of the rendered FOV is increased when the error increases, allowing the receiver to make adjustments to the final frame as it is ready to be displayed to account for the relatively large error between the predicted future head pose and the actual head pose. Conversely, if the error is relatively small, then the rendering unit generates a relatively smaller rendered FOV which makes the VR/AR system more efficient by reducing the number of pixels generated and sent to the receiver. This helps to reduce latency and the power consumption involved in preparing the frame for display when the error is small.

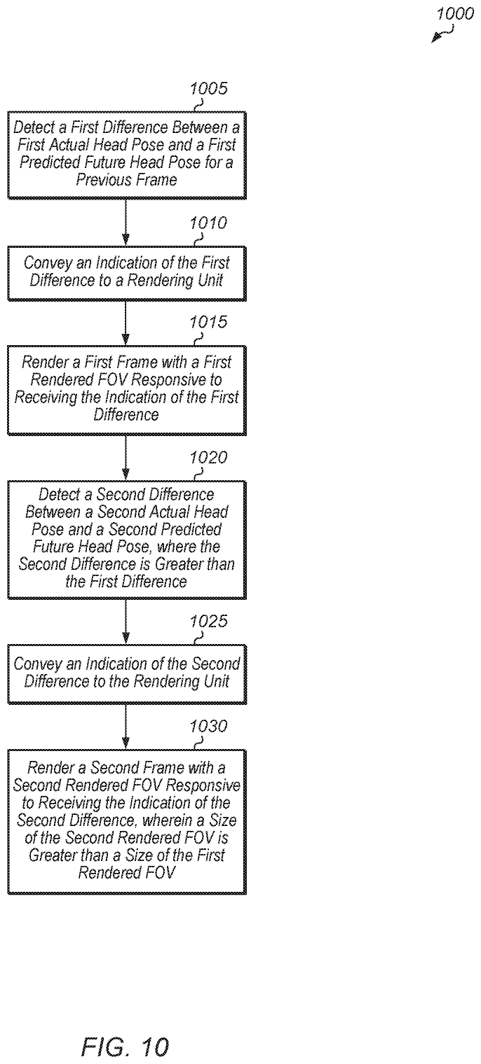

Turning now to FIG. 10, one implementation of a method 1000 for dynamically adjusting a rendering FOV is shown. A receiver detects a first difference between a first actual head pose and a first predicted future head pose for a previous frame (block 1005). Next, the receiver conveys an indication of the first difference to a rendering unit (block 1010). Then, the rendering unit renders a first frame with a first rendered FOV responsive to receiving the indication of the first difference (block 1015). In one implementation, a size of the first rendered FOV is proportional to the first difference.

Next, at a later point in time, the receiver detects a second difference between a second actual head pose and a second predicted future head pose, where the second difference is greater than the first difference (block 1020). Then, the receiver conveys an indication of the second difference to the rendering unit (block 1025). Next, the rendering unit renders a second frame with a second rendered FOV responsive to receiving the indication of the second difference, wherein a size of the second rendered FOV is greater than a size of the first rendered FOV (block 1030). After block 1030, method 1000 ends.

In various implementations, program instructions of a software application are used to implement the methods and/or mechanisms described herein. For example, program instructions executable by a general or special purpose processor are contemplated. In various implementations, such program instructions can be represented by a high level programming language. In other implementations, the program instructions can be compiled from a high level programming language to a binary, intermediate, or other form. Alternatively, program instructions can be written that describe the behavior or design of hardware. Such program instructions can be represented by a high-level programming language, such as C. Alternatively, a hardware design language (HDL) such as Verilog can be used. In various implementations, the program instructions are stored on any of a variety of non-transitory computer readable storage mediums. The storage medium is accessible by a computing system during use to provide the program instructions to the computing system for program execution. Generally speaking, such a computing system includes at least one or more memories and one or more processors configured to execute program instructions.

It should be emphasized that the above-described implementations are only non-limiting examples of implementations. Numerous variations and modifications will become apparent to those skilled in the art once the above disclosure is fully appreciated. It is intended that the following claims be interpreted to embrace all such variations and modifications.

What is claimed is:

1. A system comprising:
a receiver configured to:
measure a total latency for the system to render and prepare frames for display; and
predict a future head pose of a user based at least in part on a measurement of the total latency and a current head pose of the user;
a rendering unit configured to render, based on the predicted future head pose, a new frame with a rendered field of view (FOV) larger than a display FOV; and
a display device configured to display the new frame.

2. The system comprising as recited in claim 1, wherein the receiver is further configured to:
determine an actual head pose of the user;
calculate a difference between the actual head pose and the predicted future head pose;
rotate the new frame by an amount based on the difference to generate a rotated version of the new frame; and
display the rotated version of the new frame.

3. The system as recited in claim 1, wherein the receiver is further configured to update a model based on the difference between the actual head pose and the predicted future head pose, wherein the model generates future head pose predictions.

4. The system as recited in claim 1, wherein the receiver is further configured to:
calculate a difference between the actual head pose and the predicted future head pose; and
dynamically adjust a size of a rendered FOV of a subsequent frame based on the difference.

5. The system as recited in claim 1, wherein the receiver is further configured to determine a size of the rendered FOV for rendering the new frame based at least in part on a difference between a previous actual head pose and a previous predicted future head pose.

6. The system comprising as recited in claim 5, wherein the system is further configured to:
detect a first difference between a first actual head pose and a first predicted future head pose;
render a first frame with a first rendered FOV responsive to detecting the first difference;
detect a second difference between a second actual head pose and a second predicted future head pose, wherein the second difference is greater than the first difference; and
render a second frame with a second rendered FOV responsive to detecting the second difference, wherein a size of the second rendered FOV is greater than a size of the first rendered FOV.

7. The system as recited in claim 1, wherein the total latency is measured from a first point in time when a given head pose is measured to a second point in time when a frame corresponding to the given head pose is displayed.

8. A method comprising:
measuring, by a receiver, a total latency to render a frame and prepare the frame for display;
predicting, by the receiver, a future head pose of a user based at least in part on a measurement of the total latency and a current head pose of the user;
rendering, based on the predicted future head pose, a new frame with a rendered field of view (FOV) larger than a display FOV; and
conveying the rendered new frame for display.

9. The method as recited in claim 8, further comprising:
determining an actual head pose of the user;
calculating a difference between the actual head pose and the predicted future head pose;
rotating the new frame by an amount based on the difference to generate a rotated version of the new frame; and
displaying the rotated version of the new frame.

10. The method as recited in claim 8, further comprising updating a model based on the difference between the actual head pose and the predicted future head pose, wherein the model generates future head pose predictions.

11. The method as recited in claim 8, further comprising:
calculating a difference between the actual head pose and the predicted future head pose; and
dynamically adjusting a size of a rendered FOV of a subsequent frame based on the difference.

12. The method as recited in claim 8, further comprising determining a size of the rendered FOV for rendering the new frame based at least in part on a difference between a previous actual head pose and a previous predicted future head pose.

13. The method as recited in claim 12, further comprising:
detecting a first difference between a first actual head pose and a first predicted future head pose;
rendering a first frame with a first rendered FOV responsive to detecting the first difference;
detecting a second difference between a second actual head pose and a second predicted future head pose, wherein the second difference is greater than the first difference; and
rendering a second frame with a second rendered FOV responsive to detecting the second difference, wherein a size of the second rendered FOV is greater than a size of the first rendered FOV.

14. The method as recited in claim 8, wherein the total latency is measured from a first point in time when a given head pose is measured to a second point in time when a frame corresponding to the given head pose is displayed.

15. An apparatus comprising:
a receiver configured to:
measure a total latency for the system to render a frame and prepare the frame for display;
predict a future head pose of a user based at least in part on a measurement of the total latency and a current head pose of the user;
a rendering unit configured to:
receive an indication of the predicted future head pose;
render, based on the predicted future head pose, a new frame with a rendered field of view (FOV) larger than a display FOV; and
an encoder configured to:
encode the rendered new frame to generate an encoded frame; and
convey the rendered new frame to the receiver for display.

16. The apparatus as recited in claim 15, wherein the receiver is further configured to:
determine an actual head pose of the user in preparation for displaying the new frame;
calculate a difference between the actual head pose and the predicted future head pose;
rotate the new frame by an amount based on the difference to generate a rotated version of the new frame; and
display the rotated version of the new frame.

17. The apparatus as recited in claim 15, wherein the receiver is further configured to update a model based on the difference between the actual head pose and the predicted future head pose, wherein the model generates future head pose predictions.

18. The apparatus as recited in claim 15, wherein the receiver is further configured to:
calculate a difference between the actual head pose and the predicted future head pose; and
dynamically adjust a size of a rendered FOV of a subsequent frame based on the difference.

19. The apparatus as recited in claim 15, wherein the receiver is further configured to determine a size of the rendered FOV for rendering the new frame based at least in part on a difference between a previous actual head pose and a previous predicted future head pose.

20. The apparatus as recited in claim 19, wherein the system is further configured to:
detect a first difference between a first actual head pose and a first predicted future head pose;
render a first frame with a first rendered FOV responsive to detecting the first difference;
detect a second difference between a second actual head pose and a second predicted future head pose, wherein the second difference is greater than the first difference; and
render a second frame with a second rendered FOV responsive to detecting the second difference, wherein a size of the second rendered FOV is greater than a size of the first rendered FOV.
